(19) United States
(12) Patent Application Publication
(10) Pub. No.: US 2017/0088100 A1
(43) Pub. Date: Mar. 30, 2017

(54) WIPER BLADE ASSEMBLY

(71) Applicant: CAP Corporation, Sangju-si (KR)

(72) Inventor: Tae Hun KIM, Daegu (KR)

(73) Assignee: CAP Corporation, Sangju-si (KR)

(21) Appl. No.: 15/375,733

(22) Filed: Dec. 12, 2016

Related U.S. Application Data
(63) Continuation-in-part of application No. 14/133,200, filed on Dec. 18, 2013.

(30) Foreign Application Priority Data
Nov. 19, 2013 (KR) 10-2013-0140831

(51) Int. Cl. B60S 1/38

(52) U.S. Cl. CPC B60S 1/3801; B60S 1/381

(57) ABSTRACT

A wiper blade assembly is provided. The wiper includes an adhering member, a channel rail configured to be coupled to the adhering member, and a channel rail fixing unit configured to support the channel rail, wherein the channel rail is movable against the channel rail fixing unit in a vertical direction or a horizontal direction. A slidable movement of the channel rail from the channel rail fixing unit can be easily realized. Thus, the slidability of the channel rail can be improved, and as a result, the performance of a wiper can be improved.

### CROSS-REFERENCE TO RELATED APPLICATIONS

This application claims priority under 35 U.S.C. §121 as a continuation-in-part application of U.S. application Ser. No. 14/133,200, filed Dec. 18, 2013 with the United States Patent and Trademark Office (USPTO), which claims priority under 35 U.S.C. §119 to Korean Patent Application No. 10-2013-0140831, filed on Nov. 19, 2013 with the Korean Intellectual Property Office, the disclosure of each of which is incorporated herein in its entirety by reference.

### TECHNICAL FIELD

The present disclosure relates to a wiper blade assembly, and more particularly, to a wiper blade assembly having a structure capable of allowing an adhering member and a spoiler to freely move against each other.

### BACKGROUND

A wiper blade assembly for wiping away rain, in the case of rain, or removing foreign materials to secure a driver's visual field is disposed in a wind shield of a vehicle. The wiper blade assembly is connected to a wiper arm connected to a driving shaft connected to a wiper driving motor of the vehicle to be driven.

Here, the wiper arm and the wiper blade assembly are connected to each other through a wiper connector part. In general, the wiper blade assembly includes a clamp, to which the connector member is coupled, and the wiper arm is coupled to the connector member in a state in which the connector member is coupled to the clamp.

Meanwhile, the wiper blade assembly may be classified into a conventional type or a flat type according to the structure of a blade.

A typical wiper blade assembly includes an adhering member for wiping any foreign materials off of a windshield of a vehicle, an elastic member supporting the adhering member, and a cover member covering either end of the elastic member.

The typical wiper blade assembly also includes a coupling cover coupled to the elastic member, and the coupling cover may also be coupled to an adaptor.

However, in the case of a typical wiper blade assembly, the movement of the cover member (or a spoiler) is not free from the adhering member during the operation of the wiper blade.

More specifically, a typical wiper blade has an adhering member bent with a predetermined curvature, and a center portion of the adhering member is a predetermined distance from the surface of a windshield of a vehicle while the wiper blade is not being driven. On the other hand, during the operation of the wiper blade assembly, the adhering member is deflected such that the entire length is placed in contact with the surface of the windshield and wipes the surface of the windshield.

The curvature of the adhering member may vary from when the wiper blade assembly is being driven to when the wiper blade assembly is not being driven. However, if the cover member is not free from the movement of the adhering member, the movement of the cover member may be considerably limited even though the curvature of the adhering member can vary.

As a result, the cover member may be damaged related to stresses caused by the bending of each of the components. The limited movement of the cover member may also interfere with the variation of the curvature of the adhering member, and may thus adversely affect the wiping performance of the adhering member.

Therefore, Applicant presents herein a wiper blade assembly having a new structure, i.e., a wiper blade assembly with a different structure from that of the patented wiper blade assembly for coupling an adhering member, an elastic member and a clamp.

### SUMMARY

Aspects of the present disclosure provide a wiper blade assembly having a structure capable of allowing an adhering member and a spoiler to freely move against each other.

The objects of the present disclosure are not limited thereto, and the other objects of the present inventive concepts will be described in or be apparent from the following description of the embodiments.

In accordance with an aspect of the present disclosure, the above and other objects can be accomplished by providing a wiper blade assembly comprising: an adhering member; a channel rail configured to be coupled to the adhering member; and a channel rail fixing unit configured to support the channel rail, wherein the channel rail is movable against the channel rail fixing unit in a vertical direction or a horizontal direction.

Further, in at least one embodiment, the vertical direction is a heightwise direction of the channel rail, and the horizontal direction is a widthwise direction of the channel rail.

Further, in at least one embodiment, the channel rail includes a base body, a channel rail protrusion disposed at an upper part of the channel rail, and a channel rail connecting portion connecting the base body and the channel rail protrusion, the channel rail fixing unit includes a channel rail support unit supporting the channel rail, first-directional extensions extended from the channel rail support unit in a first direction, a first-directional extension connecting portion connected to the first-directional extensions, and a channel rail protrusion receiving part into which the channel rail protrusion is inserted, and the channel rail protrusion is movable within the channel rail protrusion receiving part in the vertical direction or the horizontal direction.

Further, in at least one embodiment, the channel rail protrusion includes a top surface, sides extended from the top surface, and contact surfaces placed in contact with the channel rail fixing unit, the sides of the channel rail protrusion include a first side extended from one side of the top surface of the channel rail protrusion and a second side extended from the other side of the top surface of the channel rail protrusion, the contact surfaces of the channel rail protrusion include a first bottom surface extended from the first side of the channel rail protrusion and a second bottom surface extended from the second side of the channel rail protrusion, the channel rail connecting portion includes contact surfaces placed in contact with the channel rail support unit, the contact surfaces of the channel rail connecting portion include a first contact surface disposed at one side of the channel rail connecting portion and a second contact surface disposed at the other side of the channel rail connecting portion, the base body includes top surfaces disposed at an upper part of the base body, and the top surfaces of the base body include a first top surface extended from the first contact surface of the channel rail connecting portion and a second top surface extended from the second contact surface of the channel rail connecting portion.

Further, in at least one embodiment, the channel rail support unit includes a first channel rail support and a second channel rail support disposed in parallel with the first channel rail support, the first-directional extensions of the channel rail support unit include a first vertical extension vertically extended from the first channel rail support and a second vertical extension vertically extended from the second channel rail support, and the first-directional extension connecting portion includes a vertical extension connecting portion connecting the first and second vertical extensions.

Further, in at least one embodiment, the channel rail support unit includes contact surfaces formed at a top thereof to contact a surface of the channel rail protrusion, the contact surfaces of the channel rail support unit include a first top surface placed in contact with a first bottom surface of the channel rail protrusion and a second top surface placed in contact with a second bottom surface of the channel rail protrusion, the channel rail support unit further includes sides placed in contact with the channel rail connecting portion, the sides of the channel rail support unit include a first side extended from the first top surface of the channel rail support unit and a second side extended from the second top surface of the channel rail support unit, the channel rail support unit further includes bottom surfaces placed in contact with the top surfaces of the base body, the bottom surfaces of the channel rail support unit include a first bottom surface extended from the first side of the channel rail support unit and a second bottom surface extended from the second side of the channel rail support unit, the vertical extensions include inner sides, respectively, which contact the sides of the channel rail protrusion, the inner sides of the vertical extensions include a first vertical extension inner side extended from the first top surface of the channel rail support unit and a second vertical extension inner side extended from the second top surface of the channel rail support unit, and the vertical extension connecting portion includes a bottom surface placed in contact with the top surface of the channel rail protrusion.

Further, in at least one embodiment, a first gap is formed between the bottom surface of the vertical extension connecting portion and the top surface of the channel rail protrusion, second gaps are formed between the bottom surfaces of the channel rail support unit and the top surfaces of the base body, the second gaps include a “2-1” gap formed between the first bottom surface of the channel rail support unit and the first top surface of the base body and a “2-2” gap formed between the second bottom surface of the channel rail support unit and the second top surface of the base body, and in a case in which the first gap and the second gaps are formed, contact surfaces where the contact surfaces of the channel rail support unit and the contact surfaces of the channel rail protrusion contact each other are formed.

Further, in at least one embodiment, third gaps are formed between the contact surfaces of the channel rail support unit and the contact surfaces of the channel rail protrusion, the third gaps include a “3-1” gap formed between the first bottom surface of the channel rail protrusion and the first top surface of the channel rail support unit and a “3-2” gap formed between the second bottom surface of the channel rail protrusion and the second top surface of the channel rail support unit, and in a case in which the third gaps are formed, a contact surface where the bottom surface of the vertical extension connecting portion and the top surface of the channel rail protrusion contact each other and contact surfaces where the bottom surfaces of the channel rail support unit and the top surfaces of the base body contact each other are formed.

Further, in at least one embodiment, fourth gaps are formed between the inner sides of the vertical extensions and the sides of the channel rail protrusion, fifth gaps are formed between the sides of the channel rail support unit and the contact surfaces of the channel rail connecting portion, the fourth gaps include a “4-1” gap formed between the first vertical extension inner side and the first side of the channel rail protrusion and a “4-2” gap formed between the second vertical extension inner side and the second side of the channel rail protrusion, and the fifth gaps include a “5-1” gap formed between the first side of the channel rail support unit and the first contact surface of the channel rail connecting portion and a “5-2” gap formed between the second side of the channel rail support unit and the second contact surface of the channel rail connecting portion.

According to the present disclosure, since channel rail fixing units and a channel rail may be formed of a plastic material, the coefficient of friction at the contact or interface between each of the channel rail fixing units and the channel rail can be reduced, and thus, the channel rail and the channel rail fixing units can easily move against each other.

An improved mobility of the channel rail and the channel rail fixing units against each other can result in an improved mobility of an adhering member, which is coupled to the channel rail. The improved mobility of the channel rail fixing units can also result in an improved mobility of spoilers, which are respectively formed in one integral body with the channel rail fixing units, and the adhering member against each other.

According to the present disclosure, channel rail fixing units can be prevented from interfering with the pressing pressure during the operation of a wiper by appropriately limiting the rigidity of the channel rail fixing units.

In addition, one or more vertical extension connecting portions of a channel rail support unit can be prevented from interfering with the pressing pressure during the operation of a wiper by appropriately limiting the thickness of the vertical extension connecting portions.

Moreover, channel rails are movable against the channel rail fixing units in a heightwise direction or a widthwise direction of the channel rails, a slidable movement of the channel rails from the channel rail fixing units can be easily realized. Thus, the slidability of the channel rails can be further improved, and as a result, the performance of a wiper can be improved.

### BRIEF DESCRIPTION OF THE DRAWINGS

FIG. 1A is a coupled perspective view illustrating a wiper blade assembly according to an embodiment.

FIG. 1B is an exploded perspective view illustrating the wiper blade assembly.

FIG. 2A is a coupled perspective view illustrating the spoilers 500, the elastic member 700 and the channel rail 800 of the wiper blade assembly 10.

FIG. 2B is an exploded perspective view illustrating the spoilers 500, the elastic member 700 and the channel rail 800 of the wiper blade assembly 10.

FIG. 3A is an exploded cross-sectional view taken along line I-I of FIG. 2A.

FIG. 3B is a coupled cross-sectional view taken along line I-I of FIG. 2A.

FIG. 4A is a cross-sectional view illustrating a first modified example of the second channel rail fixing unit 600b.

FIG. 4B is a cross-sectional view illustrating a second modified example of the second channel rail fixing unit 600b.

FIG. 4C is a cross-sectional view illustrating a third modified example of the second channel rail fixing unit 600b.

FIGS. 5A and 5B are schematic views comparing the movement of an adhering member when a wiper is being driven and the movement of the adhering member when the wiper is not being driven.

FIG. 6 is a coupled cross-sectional view of an alternative embodiment taken along line I-I of FIG. 2A.

FIG. 7 is a cross-sectional view illustrating a channel rail fixing unit 600b and a channel rail 800 according to an additional embodiment.

FIG. 8 is a cross-sectional view illustrating the movement, in a vertical direction, of the channel rail 800 according to the additional embodiment.

FIG. 9 is a cross-sectional view illustrating the movement, in a horizontal direction, of the channel rail 800 according to the additional embodiment.

### DETAILED DESCRIPTION

As required, detailed embodiments of the present inventive concepts are disclosed herein; however, it is to be understood that the disclosed embodiments are merely example of the inventive concepts that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present inventive concepts.

Advantages and features of the present disclosure and methods of accomplishing the same may be understood more readily by reference to the following detailed description of example embodiments and the accompanying drawings. The present inventive concepts may, however, be embodied in many different forms and should not be construed as being limited to the example embodiments set forth herein.

Rather, these example embodiments are provided so that this disclosure will be thorough and complete and will fully convey the concept of the inventive concepts to those skilled in the art, and the present inventive concepts will only be defined by the appended claims. Like reference numerals refer to like elements throughout the specification.

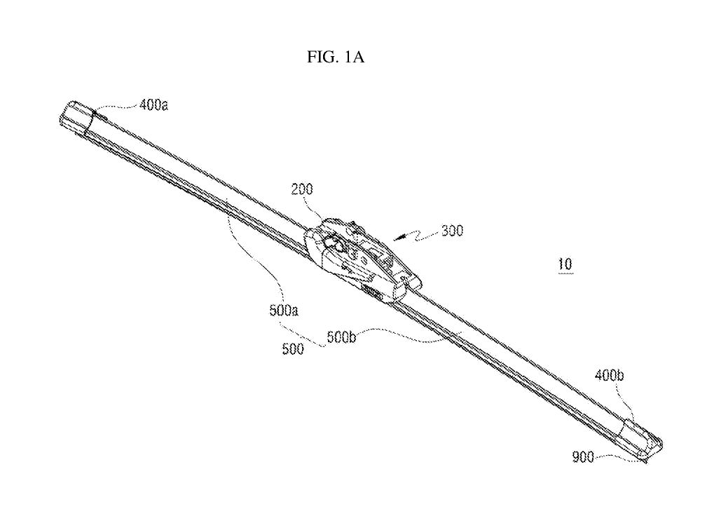

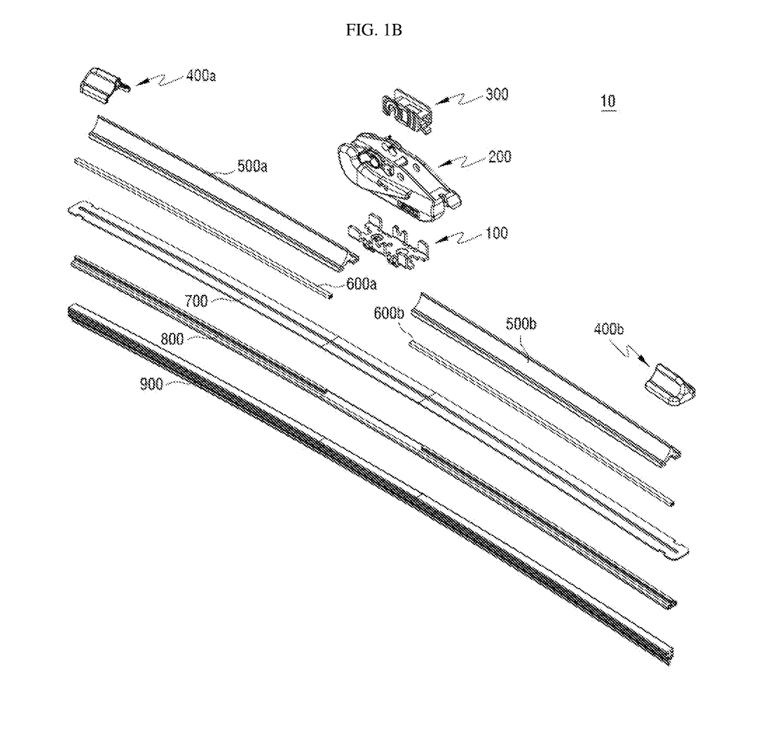

FIG. 1A is a coupled perspective view illustrating a wiper blade assembly according to an embodiment, and FIG. 1B is an exploded perspective view illustrating the wiper blade assembly.

Referring to FIGS. 1A and 1B, a wiper blade assembly 10 includes an adhering member 900 which is formed of a rubber material and is placed in contact with the wind shield of a vehicle, an elongate elastic member 700 which supports the adhering member 900, and a pair of spoilers 500 which cover the elastic member 700.

The wiper blade assembly 10 also includes a clamp 100 connected to the elastic member 700 and an adaptor coupled to the clamp 100. The adaptor 200 is connected to a connector 300. The wiper blade assembly 10 is coupled to a wiper arm (not illustrated) of the vehicle via the connector 300.

As illustrated in FIGS. 1A and 1B, the wiper blade assembly 10 also includes a channel rail 800 coupled to the adhering member 900. Once coupled to the elastic member 700, the channel rail 800 can be prevented by first and second channel rail fixing units 600a and 600b from being detached from the elastic member 700.

That is, the channel rail 800 is inserted into the elastic member 700, and is also inserted into the first and second channel rail fixing units 600a and 600b. As a result, the channel rail 800 can be prevented from being detached from the elastic member 700.

The wiper arm is coupled to the connector 300 so that the wiper blade assembly 10 can perform a wiping operation by using power applied thereto from the wiper arm.

The spoilers 500 may be respectively formed in one integral body with the first and second channel rail fixing units 600a and 600b by double extrusion.

That is, for convenience, the spoilers 500 and the first and second channel rail fixing units 600a and 600b are illustrated in FIG. 1B as being separate from each other, but may actually be formed by double extrusion to be fixed to each other.

For example, the first and second channel rail fixing units 600a and 600b and the channel rail 800 may be formed of a plastic material. In this example, the mobility of the first and second channel rail fixing units 600a and 600b against the surface of the channel rail 800 can be improved, and thus, during the operation of a wiper blade, the first and second channel rail fixing units 600a and 600b and the channel rail 800 can smoothly move against each other.

That is, by forming the first and second channel rail fixing units 600a and 600b and the channel rail 800 of a plastic material, the coefficient of friction at the contact surfaces (or the interfaces) between the channel rail 800 and the first and second channel rail fixing units 600a and 600b can be reduced, thereby facilitating a slidable movement of the channel rail 800 and the first and second channel rail fixing units 600a and 600b against each other.

An improved or facilitated mobility of the channel rail 800 and the first and second channel rail fixing units 600a and 600b against each other may mean that the first and second channel rail fixing units 600a and 600b may slidably move against the channel rail 800.

An improved mobility of the channel rail 800 and the first and second channel rail fixing units 600a and 600b against each other may result in an improved mobility of the adhering member 900, which is coupled to the channel rail 800. The improved mobility of the first and second channel rail fixing units 600a and 600b may also result in an improved mobility of the spoilers 500, which are respectively formed in one integral body with the first and second channel rail fixing units 600a and 600b, and the adhering member 900 against each other.

In the case of a related-art wiper blade, since the movement of a cover member is not free from the movement of an adhering member, the movement of the cover member may be limited even with variations in the curvature of the adhering member, and as a result, the cover member may be damaged. Loads imparted from a wiper arm to conform the wiper blade curvature to a windshield may cause both bending and shear stresses in the components. Since each component may have different shapes and materials, bending profiles may differ across each. As such, transverse shear stress can build up in the components. In addition, the limited movement of the cover member may interfere with the change of the curvature of the adhering member and may thus adversely affect the wiping performance of the adhering member.

The aforementioned problems associated with a related-art wiper blade may be addressed by improving the mobility of the spoilers 500 and the adhering member against each other. By allowing for mobility, or relative slip between the components, the above-mentioned shear stress may be avoided.

In FIGS. 1A and 1B, reference numerals 400a and 400b indicate end covers which are coupled to the spoilers 500. The present disclosure is not limited to the presence of the end covers 400a and 400b.

In an embodiment in which the channel rail 800 is inserted into a predetermined portion of the elastic member 700 and is also inserted into the first and second channel rail fixing units 600a and 600b so as to prevent the channel rail 800 from being detached from the elastic member 700, the pressing or pressure properties of a wiper blade may be important, which will hereinafter be described with reference to FIGS. 5A and 5B.

FIGS. 5A and 5B are schematic views comparing the movement of an adhering member when a wiper is being driven and the movement of the adhering member when the wiper is not being driven.

Referring to FIG. 5A, a typical wiper blade 1 has an adhering member 2 bent with a predetermined curvature.

The wiper blade 1 itself may have a constant predetermined curvature. Alternatively, the curvature of the wiper blade 1 may vary from a central part A to an edge part E of the wiper blade 1.

Referring to FIG. 5B, when a wiper is not being driven, a windshield 4 and the adhering member 2 are a predetermined distance d apart from each other. On the other hand, when the wiper is being driven, the adhering member 2 is placed in contact with the windshield 4 along its length and wipes the windshield 4.

That is, while the wiper is being driven, a predetermined pressing pressure is applied to the wiper blade 1 such that the adhering member 2 can contact the windshield 4.

In the embodiments illustrated in FIGS. 1A and 1B, the first and second channel rail fixing units 600a and 600b may resist the pressing pressure on the adhering member 900.

In order for the first and second channel rail fixing units 600a and 600b to not interfere with the pressing pressure on the adhering member 900, the rigidity of the first and second channel rail fixing units 600a and 600b may be predetermined. In this way, the first and second channel rail fixing units 600a and 600b do not interfere with the wiping operation of a wiper.

More specifically, the rigidity of the first and second channel rail fixing units 600a and 600b may be determined n consideration of the rigidity of the spoilers 500. For example, the rigidity of the first and second channel rail fixing units 600a and 600b and the rigidity of the spoilers 500 may have a ratio of about 1:1.05 to 1:1.10.

In response to the ratio of the rigidity of the first and second channel rail fixing units 600a and 600b and the rigidity of the spoilers 500 being less than 1:1.05, the first and second channel rail fixing units 600a and 600b may not be sufficiently rigid to properly fix the channel rail 800. On the other hand, in response to the ratio of the rigidity of the first and second channel rail fixing units 600a and 600b and the rigidity of the spoilers 500 being greater than 1:1.10, the first and second channel rail fixing units 600a and 600b may undesirably interfere with the pressing pressure on the adhering member 900.

For example, the spoilers 500 may have a rigidity of Shore A 85-90, and the first and second channel rail fixing units 600a and 600b may have a rigidity of Shore A 90-95.

According to the examples illustrated in FIGS. 1A and 1B, it is possible to realize a wiper blade in which the channel rail 800 can be prevented from being detached from the elastic member 700 by being inserted into the elastic member 700 and also into the first and second channel rail fixing units 600a and 600b, and in which the movement of the adhering member 900 can be free from the spoilers 500.

In addition, it is possible to prevent the first and second channel rail fixing units 600a and 600b from interfering with the pressing pressure on the adhering member 900 by determining the rigidity of the first and second channel rail fixing units 600a and 600b in consideration of the rigidity of the spoilers 500.

Each of the first and second channel rail fixing units 600a and 600b may include a channel rail support unit, which is provided for strengthening the coupling between the first and second channel rail fixing units 600a and 600b and the spoilers 500, which are respectively formed in one integral body with the first and second channel rail fixing units 600a and 600b. The channel rail support unit may include a vertical extension connecting portion, which, however, may interfere with the pressing pressure on the adhering member 900.

The thickness of the vertical extension connecting portion may be determined such that the vertical extension connecting portion may not cause too much resistance and thereby interfere with the pressing pressure on the adhering member 900. The vertical extension connecting portion will be described later in greater detail.

The structure of the wiper blade assembly 10 will hereinafter be described in greater detail.

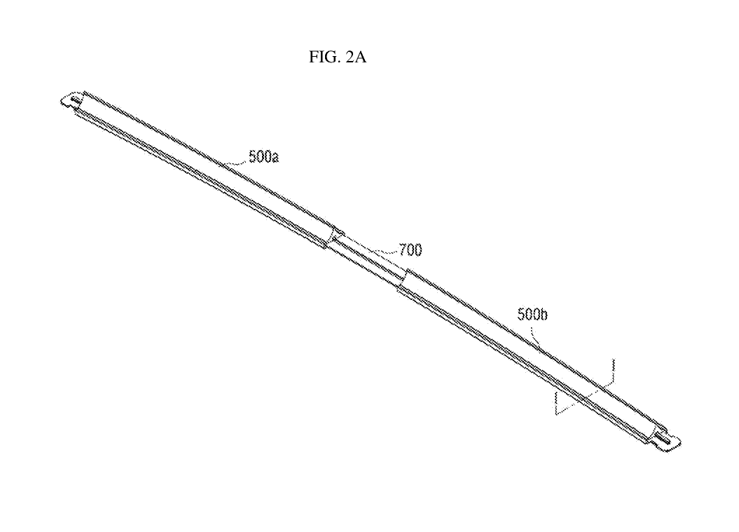

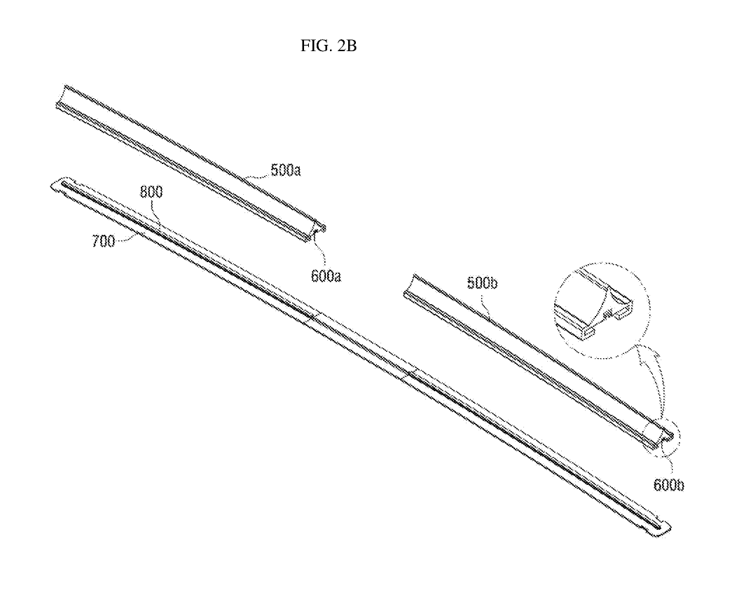

FIG. 2A is a coupled perspective view illustrating the spoilers 500, the elastic member 700 and the channel rail 800 of the wiper blade assembly 10, and FIG. 2B is an exploded perspective view illustrating the spoilers 500, the elastic member 700 and the channel rail 800 of the wiper blade assembly 10.

For convenience, the adhering member 900 illustrated in FIGS. 1A and 1B is omitted from FIGS. 2A and 2B. Even though not specifically illustrated, the adhering member 900 may be inserted into, and thus coupled to, the channel rail 800.

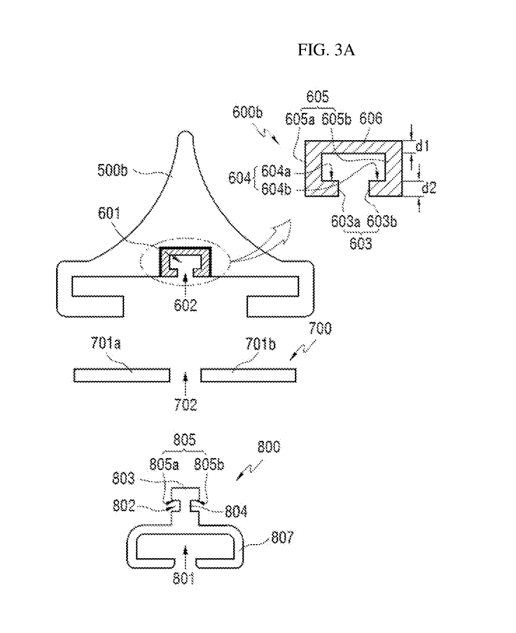

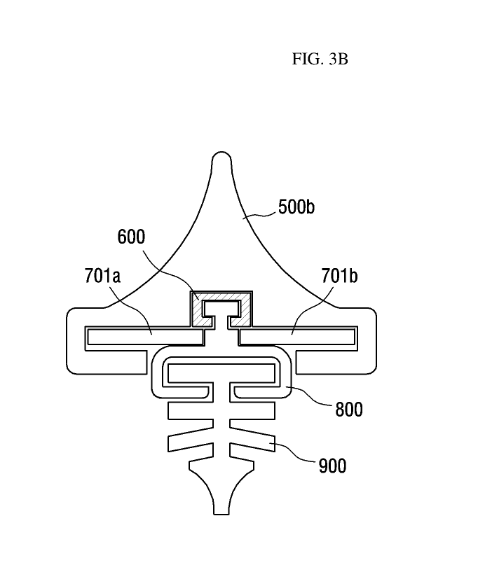

More specifically, as illustrated in FIG. 3A, the channel rail 800 includes an adhering member insertion part 801. The adhering member 900 may be coupled to the channel rail 800 by being inserted into the adhering member insertion part 801. In at least one embodiment, the adhering member 900 may be slidably engaged into an open portion of the channel rail 800.

Referring to FIGS. 2A and 2B, the spoilers 500 include first and second spoilers 500a and 500b. The first and second spoilers 500a and 500b may be formed by double extrusion to be fixed to the first and second channel rail fixing units 600a and 600b, respectively. In such a configuration, the channel rail fixing units may each comprise an integral channel embedded within a respective spoiler.

Once coupled to the elastic member 700, the channel rail 800 may be prevented from being detached from the elastic member 700 by the first and second channel rail fixing units 600a and 600b. It will be described later in detail how the first and second channel rail fixing units 600a and 600b, the elastic member 700 and the channel rail 800 are coupled to one another with reference to FIGS. 3A and 3B.

The first and second spoilers 500a and 500b are formed in one integral body with, and thus fixed to, the first and second channel rail fixing units 600a and 600b, respectively. The channel rail 800 is insertable through the elastic member 700 and is also coupled to the first and second channel rail fixing units 600a and 600b. Accordingly, the channel rail 800 can be prevented from being detached from the elastic member 700. In at least one embodiment, the wind spoilers each define a symmetrical shape having an apex and extending portions that cover outer edges of the elastic member.

It will hereinafter be described how the spoilers 500, the elastic member 700 and the channel rail 800 are coupled to one another.

FIG. 3A is an exploded cross-sectional view taken along line I-I of FIG. 2A, and FIG. 3B is a coupled cross-sectional view taken along line I-I of FIG. 2A.

Referring to FIG. 3A and 3B, the second spoiler 500b and the second channel rail fixing unit 600b are formed in one integral body with each other and are thus fixed to each other. The second spoiler 500b and the second channel rail fixing unit 600b may be formed in one integral body with each other by double extrusion, or co-extrusion.

The elastic member 700 includes a first elastic part 701a, a second elastic part 701b, which is disposed in parallel with the first elastic part 701a, and a channel rail insertion hole 702, which is disposed between the first and second elastic parts 701a and 701b. In at least one embodiment, the insertion hole 702 comprises an elongated slot formed through the elastic member 700.

The channel rail 800 includes a body 807 and the adhering member insertion part 801 disposed below the body 807. In at least one embodiment the body 807 comprises a closed portion configured to abut the elastic member 700, and an open portion directed away from the elastic member 700. By inserting the adhering member 900 into the adhering member insertion part 801, the adhering member 900 may be retained within the channel rail 800.

The channel rail 800 also includes a channel rail protrusion 803 which is inserted into, and thus supported by, the second channel rail fixing unit 600b, and a channel rail connecting portion 804 which connects the body 807 and the channel rail protrusion 803.

The channel rail protrusion 803 may include contact surfaces 805 which are provided at the bottom of the channel rail protrusion 803 and contact one surface of the second channel rail fixing unit 600b.

Referring further to FIGS. 3A and 3B, the second channel rail fixing unit 600b, which is coupled to the channel rail 800, includes a channel rail protrusion receiving part, or recess, 601. By inserting the channel rail protrusion 803 of the channel rail 800 into the channel rail protrusion receiving part 601 of the second channel rail fixing unit 600b, the channel rail 800 may be coupled to the second channel rail fixing unit 600b. In at least one embodiment, an opening of the receiving part 601 is in alignment with the insertion hole 702 of the elastic member 700.

The second channel rail fixing unit 600b may also include a channel rail support unit 603. The channel rail support unit 603 includes a first channel rail support 603a, a second channel rail support 603b, which is disposed in parallel with the first channel rail support 603a, and an insertion hole 602, which is disposed between the first and second channel rail supports 603a and 603b.

That is, the channel rail protrusion 803 of the channel rail 800 may be inserted into the channel rail protrusion receiving part 601 of the second channel rail fixing unit 600b. The channel rail connecting portion 804 cooperates with the first and second channel rail supports 603a and 603b, thereby coupling the channel rail 800 to the second channel rail fixing unit 600b.

The channel rail support unit 603 may include contact surfaces 604 which are provided at the top of the channel rail support unit 603 and contact the channel rail protrusion 803 of the channel rail 800.

That is, the contact surfaces 604 of the channel rail support unit 603 and the contact surfaces 805 of the channel rail protrusion 803 of the channel rail 800 may contact each other. Since the second channel rail fixing unit 600b and the channel rail 800 may both be formed of a plastic material, the coefficient of friction at the contact or interface between the second channel rail fixing unit 600b and the channel rail 800 may be reduced, and thus, the channel rail 800 and the second channel rail fixing unit 600b may easily move against each other.

That the channel rail 800 and the second channel rail fixing unit 600b may freely move against each other may mean that the second channel rail fixing unit 600b may slidably move along the channel rail 800, and particularly, that the contact surfaces 604 of the channel rail support unit 603 may slidably move against the contact surfaces 805 of the channel rail protrusion 803. In at least one embodiment, the cooperation of these components creates a slidable interlocking engagement between the channel rail 800 and channel rail fixing unit 600.

The second channel rail fixing unit 600b and the channel rail 800 may be formed of, but is not limited to, a plastic material, such as polycarbonate (PC) or polypropylene (PP). For example, the second channel rail fixing unit 600b may be formed of PP, and the channel rail 800 may be formed of PC.

The second spoiler 500b may be formed in one integral body with, and thus coupled to, the second channel rail fixing unit 600b. Accordingly, to couple the second channel rail fixing unit 600b to the channel rail 800, the channel rail support unit 603 and the recess 601 may be provided in the second channel rail fixing unit 600b.

Since the second channel rail fixing unit 600b and the channel rail 800 are formed of a plastic material, the coefficient of friction at the contact surface (or the interface) between the second channel rail fixing unit 600b and the channel rail 800 may be reduced, and thus, the channel rail 800 and the second channel rail fixing unit 600b may freely move against each other.

In addition, as mentioned above, the rigidity of the second channel rail fixing unit 600b may be determined in consideration of the rigidity of the second spoiler 500b such that the second channel rail fixing unit 600b does not interfere with the pressing pressure on the adhering member 900. For example, the second channel rail fixing unit 600b and the rigidity of the second spoiler 500b may have a ratio of about 1:1.05 to 1:1.10.

The structure of the second channel rail fixing unit 600b will hereinafter be described.

For convenience, the terms “vertical” and “horizontal” may be used in the description that follows, but should be considered merely example. The terms “vertical direction” and “horizontal direction,” as used herein, may be interchangeable with “first direction” and “second direction,” respectively.

Referring further to FIGS. 3A and 3B, the second channel rail fixing unit 600b includes the first and second channel rail supports 603a and 603b.

The second channel rail fixing unit 600b may also include a first vertical extension 605a which extends from the first channel rail support 603a in a first direction, for example, a vertical direction, and a second vertical extension 605b which extends from the second channel rail support 603b in the vertical direction. For convenience, the first and second vertical extensions 605a and 605b may be collectively referred to as the vertical extensions 605.

The term “vertical direction” as used herein, may be interchangeable with the term “first direction.” Accordingly, the first and second vertical extensions 605a and 605b may also be referred to as the first and second “first-directional” extensions 605a and 605b, respectively, and the vertical extensions 605 may also be referred to as the “first-directional” extensions 605.

The second channel rail fixing unit 600b may also include a vertical extension connecting portion 606 which interconnects the first and second vertical extensions 605a and 605b. The vertical extensions 605 and the vertical extension connecting portion 606 may be provided for strengthening the coupling between the second spoiler 500b and the second channel rail fixing unit 600b. The shape of the second channel rail fixing unit 600b may vary depending on the presence or absence of the vertical extensions 605 and/or the vertical extension connecting portion 606.

The term “vertical direction” as used herein, may be interchangeable with the term “first direction.” Accordingly, the vertical extension connecting portion 606 may also be referred to as the first-directional extension connecting portion 606.

The second channel rail fixing unit 600b may include a channel rail support unit, which is provided for strengthening the coupling between the second channel rail fixing unit 600b and the second spoiler 500b, which are formed in one integral body with each other. The channel rail support unit may include a vertical extension connecting portion, which, may increase stiffness and interfere with the pressing pressure on the adhering member 900.

Accordingly, the thickness of the vertical extension connecting portion may be determined such that the vertical extension connecting portion has a desirable stiffness and does not interfere with the pressing pressure on the adhering member 900.

More specifically, the vertical extension connecting portion, i.e. the first-directional extension connecting portion, may be formed to be thinner than the channel rail support unit.

For example, a thickness d1 of the vertical extension connecting portion 606 may be determined in consideration of a thickness d2 of the channel rail support unit 603 such that the thickness d1 and the thickness d2 may have a ratio d2:d1 of about 1:0.1 to 1:0.9.

In response to the ratio of the thickness d1 and the thickness d2, d2:d1, being less than 1:0.1, the vertical extension connecting portion 606 may not be able to properly support and strengthen the coupling between the second spoiler 500b and the second channel rail fixing unit 600b. On the other hand, in response to the ratio of the thickness d1 and the thickness d2, d2:d1, being greater than 1:0.9, the vertical extension connecting portion 606 may undesirably interfere with the pressing pressure on the adhering member 900.

In a non-limiting example, the thickness d2 may be about 0.1-2 mm, and the thickness d1 may be about 0.01-1.8 mm.

However, the thicknesses of the vertical extension connecting portion 606 and the channel rail support unit 603 are not limited to the numeric ranges as set forth herein. For example, in response to the thickness of the channel rail support unit 603 being determined in accordance with the specification of the wiper blade assembly 10, the thickness of the vertical extension connecting portion 606 may be appropriately determined to have a predetermined ratio with respect to the thickness of the channel rail support unit 603.

Modified examples of the second channel rail fixing unit 600b will hereinafter be described.

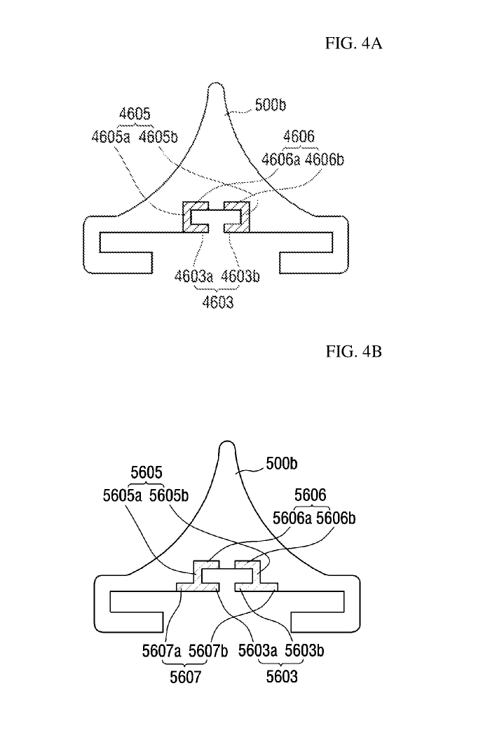

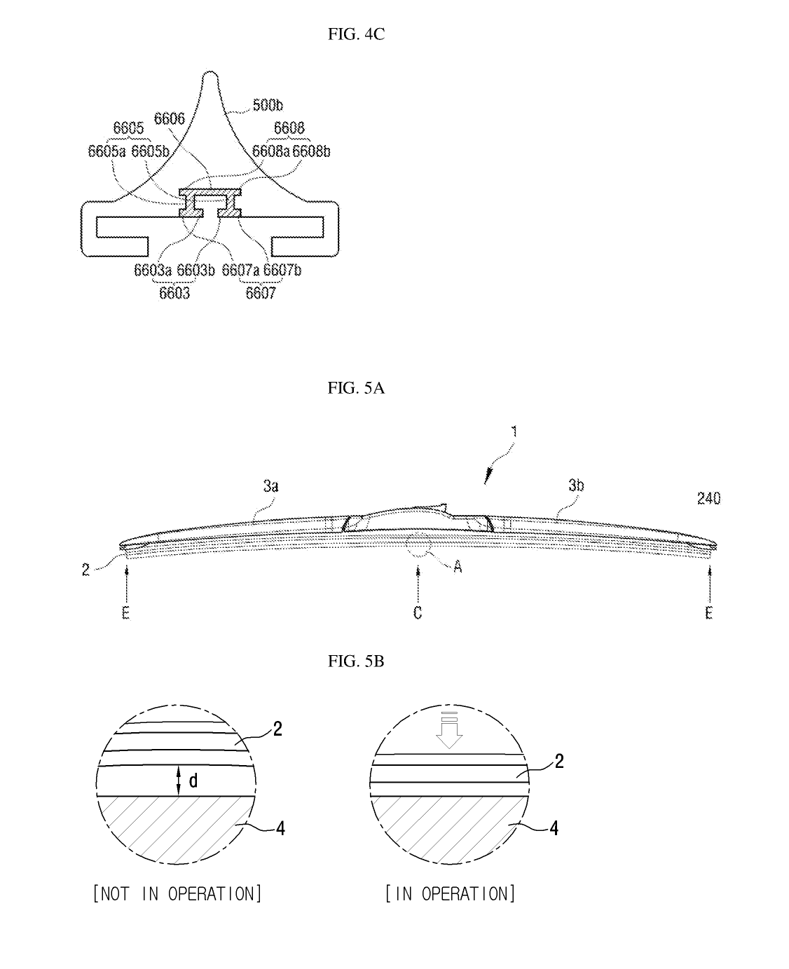

FIG. 4A is a cross-sectional view illustrating a first modified example of the second channel rail fixing unit 600b, FIG. 4B is a cross-sectional view illustrating a second modified example of the second channel rail fixing unit 600b, and FIG. 4C is a cross-sectional view illustrating a third modified example of the second channel rail fixing unit 600b.

Referring to FIG. 4A, the second channel rail fixing unit 600b may include a first channel rail support 4603a and a second channel rail support 4603b. The second channel rail fixing unit 600b may also include vertical extensions 4605, i.e., a first vertical extension 4605a vertically extended from the first channel rail support 4603a and a second vertical extension 4605b vertically extended from the second channel rail support 4603b.

The second channel rail fixing unit 600b may also include one or more vertical extension connecting portions 4606 connected to the first and second vertical extensions 4605a and 4605b. For example, the second channel rail fixing unit 600b may include a single vertical extension connecting portion 4606, as illustrated in FIG. 3A. In another example such as the illustration of FIG. 4A, the second channel rail fixing unit 600b may include two vertical extension connecting portions 4606, i.e., a first vertical extension connecting portion 4606a connected to the first vertical extension 4605a and a second vertical extension connecting portion 4606b connected to the second vertical extension 4605b, as illustrated in FIG. 4A.

Referring to FIG. 4B, the second channel rail fixing unit 600b may include a first channel rail support 5603a and a second channel rail support 5603b. The second channel rail fixing unit 600b may also include vertical extensions 5605, i.e., a first vertical extension 5605a vertically extended from the first channel rail support 5603a and a second vertical extension 5605b vertically extended from the second channel rail support 5603b.

The second channel rail fixing unit 600b may also include vertical extension connecting portions 5606, i.e., a first vertical extension connecting portion 5606a connected to the first vertical extension 5605a and a second vertical extension connecting portion 5606b connected to the second vertical extension 5605b.

The second channel rail fixing unit 600b may also include horizontal extensions 5607, i.e., a first horizontal extension 5607a horizontally extended from the first channel rail support 5603a and a second horizontal extension 5607b horizontally extended from the second channel rail support 5603b.

The term “horizontal direction”, as used herein, may be interchangeable with the term “second direction”. Accordingly, the first and second horizontal extensions 5607a and 5607b may also be referred to as the first and second “second-directional” extensions 5607a and 5607b, respectively, and the horizontal extensions 5607 may also be collectively referred to as the second-directional extensions 5607.

The term “horizontal direction”, as used herein, may be interchangeable with the term “second direction”. Accordingly, the first and second vertical extensions 605a and 605b may also be referred to as the first and second first-directional extensions 605a and 605b, respectively, and the vertical extensions 605 may also be collectively referred to as the first-directional extensions 605.

As described above, the shape of a channel rail fixing unit may vary depending on the presence or absence of first horizontal extensions, vertical extensions, vertical extension connecting portions, and second horizontal extensions, and thus should not be construed as being limited to those particular configurations set forth herein.

Referring to FIG. 4C, the second channel rail fixing unit 600a may include a first channel rail support 6603a and a second channel rail support 6603b. The second channel rail fixing unit 600b may also include vertical extensions 6605, i.e., a first vertical extension 6605a vertically extended from the first channel rail support 6603a and a second vertical extension 6605b vertically extended from the second channel rail support 6603b.

The second channel rail fixing unit 600b may also include first horizontal extensions 6607, i.e., a first horizontal extension 6607a horizontally extended from the first channel rail support 6603a and a second horizontal extension 6607b horizontally extended from the second channel rail support 6603b.

The second channel rail fixing unit 600b may also include a vertical extension connecting portion 6606 connected to the first and second vertical extensions 6605a and 6605b. The vertical extension connecting portion 6606 may include second horizontal extensions, i.e., a first horizontal extension 6608a horizontally extended from the vertical extension connecting portion 6606 in one direction and a second horizontal extension 6608b horizontally extended from the vertical extension connecting portion 6606 in the other direction.

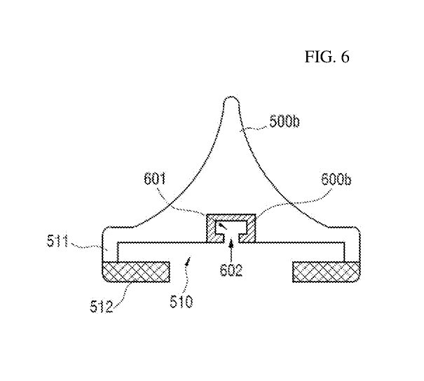

FIG. 6 is a coupled cross-sectional view taken along line I-I of FIG. 2A. More specifically, FIG. 6 illustrates a modified example of the second spoiler 500b.

The description of FIGS. 3A and 3B is also applicable to FIG. 6, and thus will not be repeated here.

Referring to FIG. 6, the second spoiler 500b, which is provided for covering the elastic member 700, accommodates therein the second channel rail fixing unit 600b for fixing the channel rail 800.

The second spoiler 500b, like its counterpart illustrated in FIGS. 3A and 3B, includes an elastic member insertion unit 510 which is provided at the bottom of the second spoiler 500b and into which the elastic member 700 is inserted. The elastic member insertion unit 510 may be configured to provide space for accommodating an elastic member support unit which supports the elastic member 700. The elastic member support unit may include an elastic member vertical support 511 supporting the lateral sides of the elastic member 700 and an elastic member horizontal support 512 supporting the bottom of the elastic member 700. In at least one embodiment, the horizontal support 512 comprises a pair of opposing wrapping portions that cover outer edges of the elastic member 700.

The second spoiler 500b and the second channel rail fixing unit 600b may be formed in one integral body with each other by double extrusion or co-extrusion, and may thus be fixed to each other.

In the second spoiler 500b, unlike in its counterpart illustrated in FIGS. 3A and 3B, the elastic member vertical support 511 and the elastic member horizontal support 512 may be formed in one integral body with each other by double extrusion, and may thus be fixed to each other.

The elastic member vertical support 511 may be formed of a typical spoiler material such as Santoprene, and the elastic member horizontal support 512 may be formed of the same material as the second channel rail fixing unit 600b, for example, PC or PP.

The elastic member 700 may be inserted into the elastic member insertion unit 510, and may thus be prevented from the second spoiler 500b by being supported by the elastic member horizontal support 512. When the elastic member 700 is inserted into, and thus supported by, the second spoiler 500b, more force may be applied to the horizontal support 512 than to other portions of the second spoiler 500b.

Accordingly, the elastic member horizontal support 512 may be formed of a more rigid material than the rest of the second spoiler 500b, and may thus be able to firmly support the elastic member 700.

An additional embodiment will hereinafter be described.

The additional embodiment relates to the structures of a channel rail fixing unit 600b and a channel rails 800.

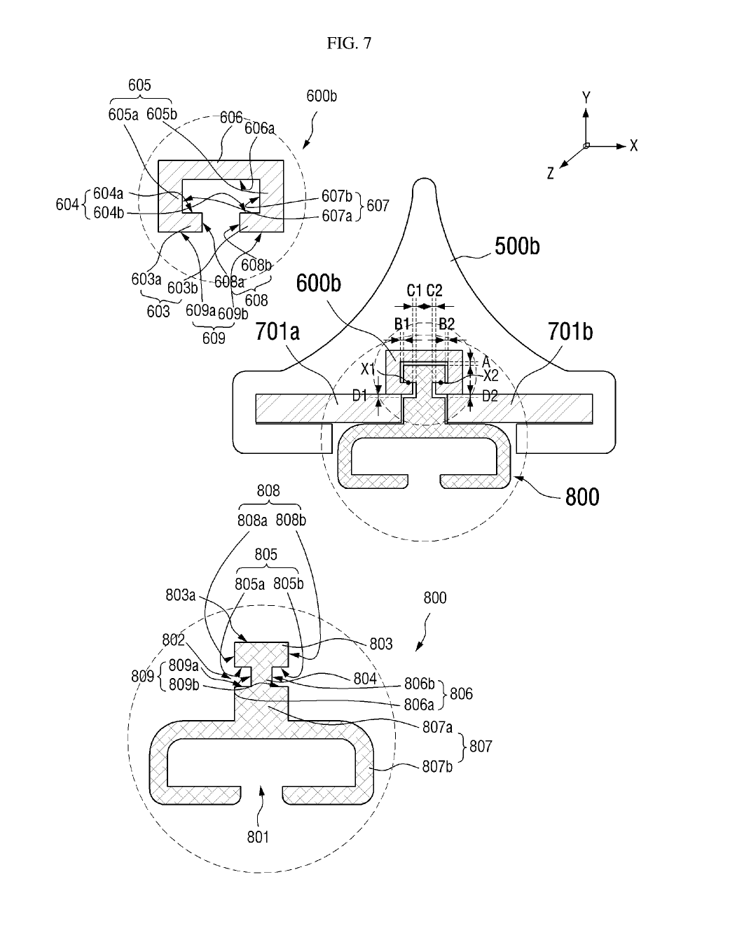

FIG. 7 is a cross-sectional view illustrating a channel rail fixing unit 600b and a channel rail 800 according to an additional embodiment.

The additional embodiment may also reference the above description with reference to FIGS. 5 and 6.

Referring to FIG. 7, as mentioned above, the spoiler 500b and the channel rail fixing unit 600b may be formed in one integral body with each other by double extrusion and may thus be fixed to each other.

An elastic member 700 includes a first elastic member 701a, a second elastic member 701b, which is disposed in parallel with the first elastic member 701a, and a channel rail insertion hole (702 of FIG. 5), which is disposed between the first and second elastic members 701a and 701b.

The channel rail 800 includes a body 807, and the body 807 includes a body portion 807a and a ring-shaped body portion 807b, which extends downwardly from the base body 807a.

The channel rail 800 further includes an adhering member insertion part 801, which is disposed below the ring-shaped body portion 807b and is provided for receiving an adhering member therein, and the channel rail 800 and the adhering member may be coupled to each other by inserting a predetermined part of the adhering member into the adhering member insertion part 801.

The channel rail 800 further includes a channel rail protrusion 803, which is disposed above the base body 807a, and a channel rail connecting portion 804, which connects the base body 807a and the channel rail protrusion 803.

The channel rail 800 further includes channel rail support unit insertion grooves 802, which are provided between the base body 807a and the channel rail protrusion 803 and are for receiving therein a channel rail support unit 603 of the channel rail fixing unit 600b that will be described later.

That is, the channel rail support unit 603 of the channel rail fixing unit 600b may be inserted into the channel rail support unit insertion grooves 802, and as a result, the channel rail 800 may be supported by the channel rail fixing unit 600b.

Referring further to FIG. 7, the channel rail protrusion 803 includes a top surface 803a and sides 808, which extend from the top surface 803a, and the sides 808 include a first side 808a, which extends from one side of the top surface 803a, and a second side 808b, which extends from the other side of the top surface 803a.

The channel rail protrusion 803 may further include contact surfaces 805 which are provided at the bottom of the channel rail protrusion 803 and contact one surface of the channel rail fixing unit 600b.

The contact surfaces 805 of the channel rail protrusion 803 include a first bottom surface 805a, which extends from the first side 808a of the channel rail protrusion 803, and a second bottom surface 805b, which extends from the second side 808b of the channel rail protrusion 803.

The contact surfaces 805 of the channel rail protrusion 803 may be defined as having a first contact surface 805a at one side of the channel rail connecting portion 804 and a second contact surface 805b at the other side of the channel rail connecting portion 804.

The channel rail connecting portion 804 includes contact surfaces 806, which contact the channel rail support unit 603, and the contact surfaces 806 include a first contact surface 806a, which is disposed at one side of the channel rail connecting portion 804, and a second contact surface 806b, which is disposed at the other side of the channel rail connecting portion 804.

The first contact surface 806a of the channel rail connecting portion 804 may be defined as extending from the first bottom surface 805a of the channel rail protrusion 805, and the second contact surface 806b of the channel rail connecting portion 804 may be defined as extending from the second bottom surface 805b of the channel rail protrusion 805.

The base body 807a includes top surfaces 809, which are provided at the top of the base body 807a, and the top surfaces 809 include a first top surface 809a, which extends from the first contact surface 806a of the channel rail connecting portion 804, and a second top surface 809b, which extends from the second contact surface 806b of the channel rail connecting portion 804.

Referring further to FIG. 7, the channel rail fixing unit 600b, which is to be coupled to the channel rail 800, includes a channel rail protrusion receiving part (601 of FIG. 5), and the channel rail 800 may be coupled to the channel rail fixing unit 600b by inserting the channel rail protrusion 803 into the channel rail protrusion receiving part.

The channel rail fixing unit 600b includes the channel rail support unit 603, and the channel rail support unit 603 includes a first channel rail support unit 603a, a second channel rail support 603b, which is disposed in parallel with the first channel rail support 603a, and an insertion hole (602 of FIG. 5), which is disposed between the first and second channel rail supports 603a and 603b.

That is, the channel rail 800 may be coupled to the channel rail fixing unit 600b with the channel rail protrusion 803 inserted in the channel rail protrusion receiving part and with the channel rail connecting portion 804 inserted in the insertion hole.

The channel rail support unit 603 includes contact surfaces 604, which are provided at the top of the channel rail support unit 603 and contact one surface of the channel rail protrusion 803.

The contact surfaces 604 of the channel rail support unit 603 include a first top surface 604a, which contacts the first bottom surface 805a of the channel rail protrusion 803, and a second top surface 604b, which contacts the second bottom surface 805b of the channel rail protrusion 803.

The channel rail support unit 603 further includes a first vertical extension 605a, which extends in a vertical direction of the first channel rail support 603a, i.e., a first direction, and a second vertical extension 605b, which extends in a vertical direction of the second channel rail support 603b, i.e., the first direction. For convenience, the first and second vertical extensions 605a and 605b may be collectively referred to as the vertical extensions 605.

The term “vertical direction,” as used herein, may be interchangeable with the term “first direction.” Accordingly, the first and second vertical extensions 605a and 605b may also be referred to as the first and second first-directional extensions 605a and 605b, respectively, and the vertical extensions 605 may also be referred to as the first-directional extensions 605.

The channel rail support unit 603 further includes a vertical extension connecting portion 606, which interconnects the first and second vertical extensions 605a and 605b. The vertical extensions 605 and the vertical extension connecting portion 606 may be provided for strengthening the coupling between the spoiler 500b and the channel rail fixing unit 600b, which are formed in one integral body and are thus fixed to each other. The shape of the channel rail fixing unit 600b may vary depending on the presence or absence of the vertical extensions 605 and/or the vertical extension connecting portion 606. Further detailed descriptions of the vertical extensions 605 and the vertical extension connecting portion 606 will be omitted.

The term “vertical direction” as used herein, may be interchangeable with the term “first direction.” Accordingly, the vertical extension connecting portion 606 may also be referred to as the first-directional extension connecting portion 606.

That is, the channel rail fixing unit 600b includes the channel rail support unit 603, which supports the channel rail 800, and the channel rail support unit 603 is provided for strengthening the coupling between the spoiler 500b and the channel rail fixing unit 600b, which are formed in one integral body with each other.

Referring further to FIG. 7, as mentioned above, the channel rail support unit 603 includes the first channel rail support 603a and the second channel rail support 603b, which is disposed in parallel with the first channel rail support 603a.

The channel rail support unit 603 further includes the contact surfaces 604, and the contact surfaces 604 include the first top surface 604a, which contacts the first bottom surface 805a of the channel rail protrusion 803, and the second top surface 604b, which contacts the second bottom surface 805b of the channel rail protrusion 803.

The channel rail support unit 603 further includes sides 608, which contact the channel rail connecting portion 804, and the sides 608 include a first side 608a, which extends from the first top surface 604a of the channel rail support unit 603, and a second side 608b, which extends from the second top surface 604b of the channel rail support unit 603.

The first side 608a of the channel rail support unit 603 may contact the first contact surface 806a of the channel rail connecting portion 804, and the second side 608b of the channel rail support unit 603 may contact the second contact surface 806b of the channel rail connecting portion 804.

The channel rail support unit 603 further includes bottom surfaces 609, which contact the top surfaces 809 of the base body 807a, and the bottom surfaces 609 include a first bottom surface 609a, which extends from the first side 608a of the channel rail support unit 603, and a second bottom surface 609b, which extends from the second side 608b of the channel rail support unit 603.

The first bottom surface 609a of the channel rail support unit 603 may contact the first top surface 809a of the base body 807a, and the second bottom surface 609a of the channel rail support unit 603 may contact the second top surface 809b of the base body 807a.

As mentioned above, the channel rail support unit 603 further includes the first vertical extension 605a, which extends in the vertical direction of the first channel rail support 603a, i.e., the first direction, and the second vertical extension 605b, which extends in the vertical direction of the second channel rail support 603b, i.e., the first direction. For convenience, the first and second vertical extensions 605a and 605b may be collectively referred to as the vertical extensions 605.

The vertical extensions 605 may include inner sides 607, respectively, which contact the sides 808 of the channel rail protrusion 803, and the inner sides 607 include first and second inner sides 607a and 607b.

The first inner side 607a of the first vertical extension 605a extends from the first top surface 604a of the channel rail support unit 603, and the second inner side 607b of the second vertical extension 605b extends from the second top surface 604b of the channel rail support unit 603.

The first inner side 607a of the first vertical extension 605a may contact the first side 808a of the channel rail protrusion 803, and the second inner side 607b of the second vertical extension 605b may contact the second side 808b of the channel rail protrusion 803.

Referring further to FIG. 7, as mentioned above, the channel rail fixing unit 600b further includes the vertical extension connecting portion 606, which interconnects the first and second vertical extensions 605a and 605b.

The vertical extension connecting portion 606 includes a bottom surface 606a, which contacts the top surfaces 803a of the channel rail protrusion 803. One end of the bottom surface 606a is connected to the first inner side 607a of the first vertical extension 605a, and the other end of the bottom surface 606a is connected to the second inner side 607b of the second vertical extension 605b.

The contact surfaces 604 of the channel rail support unit 603 and the contact surfaces 805 of the channel rail protrusion 803 may contact each other. Since the channel rail fixing unit 600b and the channel rail 800 may both be formed of a plastic material, the coefficient of friction at the contact or interface between the channel rail fixing unit 600b and the channel rail 800 may be reduced, and thus, the channel rail 800 may easily move against the channel rail fixing unit 600b.

That the channel rail 800 may easily move against the channel rail fixing unit 600b may mean that the channel rail 800 may slidably move against the channel rail fixing unit 600b, and particularly, that the contact surfaces 604 of the channel rail support unit 603 may slidably move against the contact surfaces 805 of the channel rail protrusion 803.

That the channel rail 800 may slidably move against the channel rail fixing unit 600b may mean that the channel rail 800 may move in its lengthwise direction, for example, a Z-axis direction.

That is, by allowing the channel rail 800 to slidably move against the channel rail fixing unit 600b in its lengthwise direction (or the Z-axis direction), the mobility of the adhering member, which is coupled to the channel rail 800, and the mobility of the adhering member and the channel rail fixing unit 600b against each other may both be improved.

As a result, the mobility of the spoiler 500b, which is formed in one integral body with the channel rail fixing unit 600b, and the adhering member against each other may also be improved.

Accordingly, the performance of a wiper may be improved by placing the adhering member in contact with a glass surface of a vehicle to meet variations in the curvature of the vehicle without being interfered with by the variation of the curvature of the vehicle.

The additional embodiment is further characterized in that the channel rail 800 may be movable in a vertical direction (or a Y-axis direction) or a horizontal direction (or an X-axis direction) to be freely movable against the channel rail fixing unit 600b.

More specifically, the channel rail protrusion 803 of the channel rail 800 may be movable within the channel rail protrusion receiving part (601 of FIG. 5) of the channel rail fixing unit 600b in the vertical direction (or the Y-axis direction) or the horizontal direction (or the X-axis direction).

The term “vertical direction”, as used herein, may be defined as a heightwise direction of the channel rail 800 (or the Y-axis direction), and the term “horizontal direction”, as used herein, may be defined as a widthwise direction of the channel rail 800 (or the X-axis direction).

That is, according to the additional embodiment, the channel rail 800 may move against the channel rail fixing unit 600b in its heightwise direction (or the Y-axis direction) or in its widthwise direction (or the X-axis direction). Thus, a slidable movement of the channel rail 800 from the channel rail fixing unit 600b may be easily realized. Accordingly, the slidability of the channel rail 800 may be improved, and as a result, the performance of a wiper may be improved.

The movement of the channel rail 800 in the vertical direction or the horizontal direction may be realized by structures that will hereinafter be described.

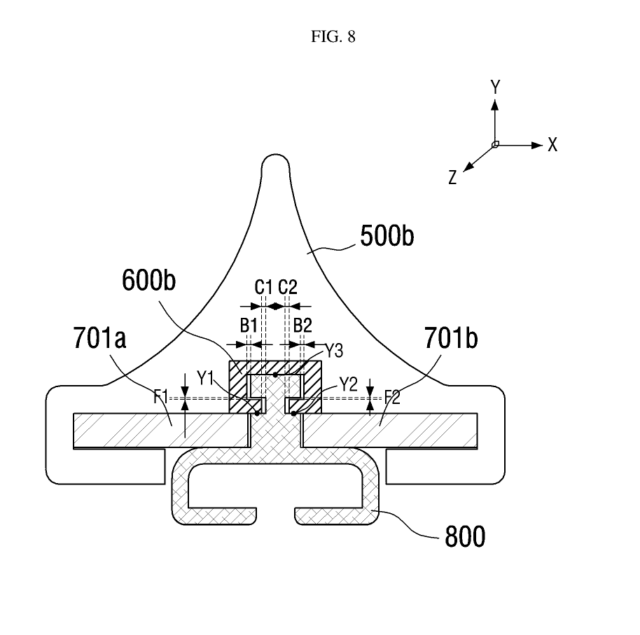

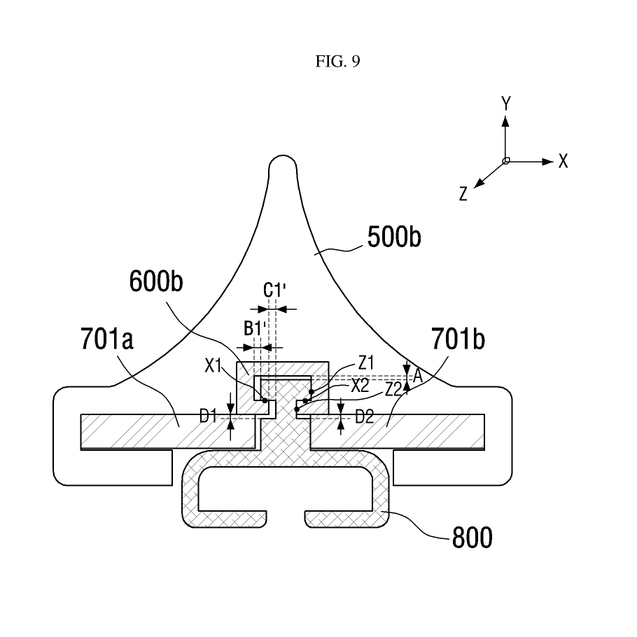

FIG. 8 is a cross-sectional view illustrating the movement, in the vertical direction, of the channel rail 800 according to the additional embodiment, and FIG. 9 is a cross-sectional view illustrating the movement, in the horizontal direction, of the channel rail 800 according to the additional embodiment.

The movement of the channel rail 800 against the channel rail fixing unit 600b in the vertical direction or the horizontal direction will hereinafter be described with reference to FIGS. 7 through 9.

First, the movement of the channel rail 800 in the vertical direction will hereinafter be described.

Referring to FIG. 7, a first gap A is formed between the bottom surface 606a of the vertical extension connecting portion 606 and the top surface 803a of the channel rail protrusion 803, and second gaps D are formed between the bottom surfaces 609 of the channel rail support unit 603 and the top surfaces 809 of the base body 807a.

The second gaps D include a “2-1” gap D1, which is formed between the first bottom surface 609a of the channel rail support unit 603 and the first top surface 809a of the base body 807a, and a “2-2” gap D2, which is formed between the second bottom surface 609b of the channel rail support unit 603 and the second top surface 809b of the base body 807a.

In a case in which the first gap A and the second gaps D are formed, contact surfaces (X1 and X2) where the contact surfaces 604 of the channel rail support unit 603 and the contact surfaces 805 of the channel rail protrusion 803 contact each other may be formed.

More specifically, a first contact surface X1 may be formed between the first bottom surface 805a of the channel rail protrusion 803 and the first top surface 604a of the channel rail support unit 603, and a second contact surface X2 may be formed between the second bottom surface 805b of the channel rail protrusion 803 and the second top surface 604b of the channel rail support unit 603.

Referring to FIG. 8, since the first gap A and the second gaps D may be formed, the channel rail 800 may move against the channel rail fixing unit 600b in the vertical direction during its slidable movement against the channel rail fixing unit 600b in its lengthwise direction.

That is, as illustrated in FIG. 8, as the channel rail 800 moves against the channel rail fixing unit 600b in the vertical direction, third gaps F may be formed between the contact surfaces 604 of the channel rail support unit 603 and the contact surfaces 805 of the channel rail protrusion 803.

More specifically, a “3-1” gap F1 may be formed between the first bottom surface 805a of the channel rail protrusion 803 and the first top surface 604a of the channel rail support unit 603, and a “3-2” gap F2 may be formed between the second bottom surface 805b of the channel rail protrusion 803 and the second top surface 604b of the channel rail support unit 603.

In a case in which the third gaps F are formed, a third contact surface Y3 where the bottom surface 606a of the vertical extension connecting portion 606 and the top surface 803a of the channel rail protrusion 803 contact each other may be formed, and contact surfaces (Y1 and Y2) where the bottom surfaces 609 of the channel rail support unit 603 and the top surfaces 809 of the base body 807a contact each other, i.e., a fourth contact surface Y1 where the first bottom surface 609a of the channel rail support unit 603 and the first top surface 809a of the base body 807a contact each other and a fifth contact surface Y2 where the second bottom surface 609b of the channel rail support unit 603 and the second top surface 809b of the base body 807a contact each other, may be formed.

That is, as areas that form the gaps of FIG. 7 form the contact surfaces of FIG. 8 and areas that form the contact surfaces of FIG. 7 form the gaps of FIG. 8, the channel rail 800 may become movable against the channel rail fixing unit 600b in the vertical direction.

The state of the channel rail 800, illustrated in FIG. 7, may be the initial state of the channel rail 800, and the state of the channel rail 800, illustrated in FIG. 8, may be a state in which the channel rail 800 is moved in the vertical direction. Alternatively, the state of the channel rail 800, illustrated in FIG. 8, may be the initial state of the channel rail 800, and the state of the channel rail 800, illustrated in FIG. 7, may be the state in which the channel rail 800 is moved in the vertical direction.

The movement of the channel rail 800 in the horizontal direction will hereinafter be described.

Referring to FIG. 7, fourth gaps B are formed between the inner sides 607 of the vertical extensions 605 and the sides 808 of the channel rail protrusion 803, and fifth gaps C are formed between the sides 608 of the channel rail support unit 603 and the contact surfaces 806 of the channel rail connecting portion 804.

The fourth gaps B include a “4-1” gap B1, which is formed between the first inner side 607a of the first vertical extension 605a and the first side 808a of the channel rail protrusion 803, and a “4-2” gap B2, which is formed between the second inner side 607b of the second vertical extension 605b and the second side 808b of the channel rail protrusion 803.

The fifth gaps C include a “5-1” gap C1, which is formed between the first side 608a of the channel rail support unit 603 and the first contact surface 806a of the channel rail connecting portion 804, and a “5-2” gap C2, which is formed between the second side 608b of the channel rail support unit 603 and the second contact surface 806b of the channel rail connecting portion 804.

Referring to FIG. 9, since the fourth gaps B and the fifth gaps C may be formed, the channel rail 800 may move against the channel rail fixing unit 600b in the horizontal direction during its slidable movement against the channel rail fixing unit 600b in its lengthwise direction.

That is, as illustrated in FIG. 9, as the channel rail 800 moves against the channel rail fixing unit 600b in a rightward direction, the “4-1” gap B1, which is formed between the first inner side 607a of the first vertical extension 605a and the first side 808a of the channel rail protrusion 803, may be widened and transformed into a “4-1′” gap B1′, and the “4-2” gap B2, which is formed between the second inner side 607b of the second vertical extension 605b and the second side 808b of the channel rail protrusion 803, may form a sixth contact surface Z1 where the second inner side 607b of the second vertical extension 605b and the second side 808b of the channel rail protrusion 803 contact each other.

Also, the “5-1” gap C1, which is formed between the first side 608a of the channel rail support unit 603 and the first contact surface 806a of the channel rail connecting portion 804, may be widened and transformed into a “5-1′” gap C1′, and the “5-2” gap C2, which is formed between the second side 608b of the channel rail support unit 603 and the second contact surface 806b of the channel rail connecting portion 804, may form a seventh contact surface Z2 where the second side 608b of the channel rail support unit 603 and the second contact surface 806b of the channel rail connecting portion 804 contact each other.

That is, as areas that form some of the gaps of FIG. 7 form the contact surfaces of FIG. 9, the channel rail 800 may become movable against the channel rail fixing unit 600b in the rightward direction.

The channel rail 800 may also become movable against the channel rail fixing unit 600b in the opposite direction to the direction in which the channel rail 800 may become movable against the channel rail fixing unit 600b in a state illustrated in FIG. 9, i.e., in a leftward direction.

The state of the channel rail 800, illustrated in FIG. 7, may be the initial state of the channel rail 800, and the state of the channel rail 800, illustrated in FIG. 9, may be a state in which the channel rail 800 is moved in the rightward direction. Alternatively, the state of the channel rail 800, illustrated in FIG. 9, may be the initial state of the channel rail 800, and the state of the channel rail 800, illustrated in FIG. 7, may be the state in which the channel rail 800 is moved in the leftward direction.

As mentioned above, the fourth gaps B include the “4-1” gap B1, which is formed between the first inner side 607a of the first vertical extension 605a and the first side 808a of the channel rail protrusion 803, and the “4-2” gap B2, which is formed between the second inner side 607b of the second vertical extension 605b and the second side 808b of the channel rail protrusion 803, and the fifth gaps C include the “5-1” gap C1, which is formed between the first side 608a of the channel rail support unit 603 and the first contact surface 806a of the channel rail connecting portion 804, and the “5-2” gap C2, which is formed between the second side 608b of the channel rail support unit 603 and the second contact surface 806b of the channel rail connecting portion 804.

In an example embodiment, the “4-1”, “4-2”, “5-1”, and “5-2” gaps B1, B2, C1, and C2 may all be provided, as illustrated in FIG. 7. In another example embodiment, the “4-1” and “5-1” gaps B1 and C1 may be provided, and the “4-2” and “5-2” gaps B2 and C2 may form contact surfaces, as illustrated in FIG. 9. In another example embodiment, the “4-2” and “5-2” gaps B2 and C2 may be provided, and the “4-1” and “5-1” gaps B1 and C1 may form contact surfaces, which is opposite to what is illustrated in FIG. 9.

FIG. 8 illustrates the movement of the channel rail 800 in the vertical direction, and FIG. 9 illustrates the movement of the channel rail 800 in the horizontal direction, particularly, in the rightward direction. However, the present disclosure is not limited to the examples of FIGS. 8 and 9. That is, the movement of the channel rail 800 in the vertical direction and the movement of the channel rail 800 in the horizontal direction may be performed at the same time.

According to the additional embodiment, the channel rail 800 may move against the channel rail fixing unit 600b in its heightwise direction (or the vertical direction) or its widthwise direction (or the horizontal direction). Thus, a slidable movement of the channel rail 800 from the channel rail fixing unit 600b may be easily realized. Accordingly, the slidability of the channel rail 800 may be improved, and as a result, the performance of a wiper may be improved.

While example embodiments are described above, it is not intended that these embodiments describe all possible forms of the inventive concepts. Rather, the words used in the specification are words of description rather than limitation, and it is understood that various changes may be made without departing from the spirit and scope of the inventive concepts. Additionally, the features of various implementing embodiments may be combined to form further embodiments of the inventive concepts.

What is claimed is:

1. A wiper blade assembly, comprising:
an adhering member;
a channel rail configured to be coupled to the adhering member; and
a channel rail fixing unit configured to support the channel rail,
wherein the channel rail is movable against the channel rail fixing unit in a vertical direction or a horizontal direction.

2. The wiper blade assembly of claim 1, wherein
the vertical direction is a heightwise direction of the channel rail, and
the horizontal direction is a widthwise direction of the channel rail.

3. The wiper blade assembly of claim 1, wherein
the channel rail includes a base body, a channel rail protrusion disposed at an upper part of the channel rail, and a channel rail connecting portion connecting the base body and the channel rail protrusion,
the channel rail fixing unit includes a channel rail support unit supporting the channel rail, first-directional extensions extended from the channel rail support unit in a first direction, a first-directional extension connecting portion connected to the first-directional extensions, and a channel rail protrusion receiving part into which the channel rail protrusion is inserted, and
the channel rail protrusion is movable within the channel rail protrusion receiving part in the vertical direction or the horizontal direction.

4. The wiper blade assembly of claim 3, wherein
the channel rail protrusion includes a top surface, sides extended from the top surface, and contact surfaces placed in contact with the channel rail fixing unit,
the sides of the channel rail protrusion include a first side extended from one side of the top surface of the channel rail protrusion and a second side extended from the other side of the top surface of the channel rail protrusion,
the contact surfaces of the channel rail protrusion include a first bottom surface extended from the first side of the channel rail protrusion and a second bottom surface extended from the second side of the channel rail protrusion,
the channel rail connecting portion includes contact surfaces placed in contact with the channel rail support unit,
the contact surfaces of the channel rail connecting portion include a first contact surface disposed at one side of the channel rail connecting portion and a second contact surface disposed at the other side of the channel rail connecting portion,
the base body includes top surfaces disposed at an upper part of the base body, and
the top surfaces of the base body include a first top surface extended from the first contact surface of the channel rail connecting portion and a second top surface extended from the second contact surface of the channel rail connecting portion.

5. The wiper blade assembly of claim 4, wherein
the channel rail support unit includes a first channel rail support and a second channel rail support disposed in parallel with the first channel rail support,
the first-directional extensions of the channel rail support unit include a first vertical extension vertically extended from the first channel rail support and a second vertical extension vertically extended from the second channel rail support, and
the first-directional extension connecting portion includes a vertical extension connecting portion connecting the first and second vertical extensions.

6. The wiper blade assembly of claim 5, wherein
the channel rail support unit includes contact surfaces formed at a top thereof to contact a surface of the channel rail protrusion,
the contact surfaces of the channel rail support unit include a first top surface placed in contact with the first bottom surface of the channel rail protrusion and a second top surface placed in contact with the second bottom surface of the channel rail protrusion,
the channel rail support unit further includes sides placed in contact with the channel rail connecting portion,
the sides of the channel rail support unit include a first side extended from the first top surface of the channel rail support unit and a second side extended from the second top surface of the channel rail support unit,
the channel rail support unit further includes bottom surfaces placed in contact with the top surfaces of the base body,
the bottom surfaces of the channel rail support unit include a first bottom surface extended from the first side of the channel rail support unit and a second bottom surface extended from the second side of the channel rail support unit,
the vertical extensions include inner sides, respectively, which contact the sides of the channel rail protrusion,
the inner sides of the vertical extensions include a first vertical extension inner side extended from the first top surface of the channel rail support unit and a second vertical extension inner side extended from the second top surface of the channel rail support unit, and
the vertical extension connecting portion includes a bottom surface placed in contact with the top surface of the channel rail protrusion.

7. The wiper blade assembly of claim 6, wherein
a first gap is formed between the bottom surface of the vertical extension connecting portion and the top surface of the channel rail protrusion,
second gaps are formed between the bottom surfaces of the channel rail support unit and the top surfaces of the base body,
the second gaps include a “2-1” gap formed between the first bottom surface of the channel rail support unit and the first top surface of the base body and a “2-2” gap formed between the second bottom surface of the channel rail support unit and the second top surface of the base body, and
in a case in which the first gap and the second gaps are formed, contact surfaces where the contact surfaces of the channel rail support unit and the contact surfaces of the channel rail protrusion contact each other are formed.

8. The wiper blade assembly of claim 6, wherein
third gaps are formed between the contact surfaces of the channel rail support unit and the contact surfaces of the channel rail protrusion,
the third gaps include a “3-1” gap formed between the first bottom surface of the channel rail protrusion and the first top surface of the channel rail support unit and a “3-2” gap formed between the second bottom surface of the channel rail protrusion and the second top surface of the channel rail support unit, and
in a case in which the third gaps are formed, a contact surface where the bottom surface of the vertical extension connecting portion and the top surface of the channel rail protrusion contact each other and contact surfaces where the bottom surfaces of the channel rail support unit and the top surfaces of the base body contact each other are formed.

9. The wiper blade assembly of claim 6, wherein
fourth gaps are formed between the inner sides of the vertical extensions and the sides of the channel rail protrusion,
fifth gaps are formed between the sides of the channel rail support unit and the contact surfaces of the channel rail connecting portion,
the fourth gaps include a “4-1” gap formed between the first vertical extension inner side and the first side of the channel rail protrusion and a “4-2” gap formed between the second vertical extension inner side and the second side of the channel rail protrusion, and
the fifth gaps include a “5-1” gap formed between the first side of the channel rail support unit and the first contact surface of the channel rail connecting portion and a “5-2” gap formed between the second side of the channel rail support unit and the second contact surface of the channel rail connecting portion.
